(19) United States
(12) Patent Application Publication
(10) Pub. No.: US 2008/0049191 A1
(43) Pub. Date: Feb. 28, 2008

(54) PROJECTOR INCLUDING OPTICAL DEVICE

(75) Inventor: Takashi ENDO, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/837,232

(22) Filed: Aug. 10, 2007

(30) Foreign Application Priority Data
Aug. 24, 2006 (JP) 2006-227460
Jun. 20, 2007 (JP) 2007-162296

(51) Int. Cl. G03B 21/14

(52) U.S. Cl. 353/22; 353/20

(57) ABSTRACT

A projector that includes an optical device is provided. The optical device includes a first flat plate formed of a negative uniaxial refractive material, the first plate having an incidence plane and an emission plane parallel to each other and having an optical axis and a second flat plate formed of a positive uniaxial refractive material, the second flat plate having an incidence plane and an emission plane parallel to the incidence plane of the first flat plate; respectively, and having an optical axis substantially parallel to the optical axis of the first flat plate. In the optical device of the projector, a predetermined phase difference is given to light using the first and second flat plates as a pair by adjusting the thickness of the first flat plate and the thickness of the second flat plate.

### BACKGROUND

1. Technical Field

The present invention relates to a projector having built therein an optical device used for various applications such as image formation.

2. Related Art

As a projector of the past, there is a projector that controls transmitted light to form image light using a liquid crystal light bulb in which a pair of sheet polarizers are arranged before and behind a liquid crystal panel. In such a projector, for example, a phase difference film for compensation is arranged between the liquid crystal panel and the incidence sheet polarizer to compensate for phase shift caused by birefringence due to pre-tilt remaining in liquid crystal and improve contrast (see JP-A-2001-343623).

However, since the phase difference film is usually formed of an organic material, reliability of the phase difference film concerning durability, accuracy, and the like is low. It is conceivable to replace the phase difference film with a phase difference plate of an inorganic material. However, in this case, since a birefringence of the material is fixed as a physical property, it is likely that an extremely thin phase difference plate has to be formed by grinding, etching, or the like. However, in general, it is not easy to form a thin phase difference plate with grinding. Even if the thin phase difference plate is successfully formed by etching or the like, since strength of the phase difference plate is insufficient, cracks and the like tend to frequently occur in the phase difference plate in a bonding process after the formation.

### SUMMARY

An advantage of some aspects of the invention is to provide a projector that includes an optical device including a phase difference plate or the like that has high reliability and sufficient strength and can relatively easily form birefringence.

According to an aspect of the invention, there is provided a projector that includes an optical device for image formation and the like. The optical device includes (a) a first flat plate formed of a negative uniaxial refractive material, the first plate having an incidence plane and an emission plane parallel to each other and having an optical axis and (b) a second flat plate formed of a positive uniaxial refractive material, the second flat plate having an incidence plane and an emission plane parallel to the incidence plane of the first flat plate, respectively, and having an optical axis substantially parallel to the optical axis of the first flat plate. In the optical device of the projector, a predetermined phase difference is given to light using the first and second flat plates as a pair by adjusting the thickness of the first flat plate and the thickness of the second flat plate. The optical axis of the first flat plate and the optical axis of the second flat plate are substantially parallel to each other. This means that not only a state in which the optical axes of the flat plates are parallel to each other in a strict sense but also a state close to this state are included in “substantially parallel”. For example, taking into account a refractive index difference of the flat plates, this includes a state in which light passing through the first flat plate along the optical axis thereof passes through the second flat plate substantially along the optical axis thereof.

In the optical device of the projector, the predetermined phase difference is given to light using the first and second flat plates as a pair by adjusting the thickness of the first flat plate and the thickness of the second flat plate. Thus, it is possible to regard that uniaxial birefringence remaining after offsetting negative uniaxiality due to the first flat plate and positive uniaxiality due to the second flat plate is pseudo-birefringence. In other words, it is possible to realize pseudo-birefringence corresponding to a relatively small relative difference using the flat plates as a pair without reducing the thicknesses of the first and second flat plates. Consequently, it is possible to easily and accurately give a target relatively small predetermined phase difference to the light. It is possible to provide an optical device that includes, as optical compensating means, a pair of flat plates that can compensate for phase shift of other portions such as a liquid crystal panel.

According to another aspect of the invention, the optical axis of the first flat plate and the optical axis of the second flat plate are arranged such that a ray that is parallel to the optical axis of the first flat palate when the ray is transmitted through the first flat plate changes to a ray that is parallel to the optical axis of the second flat plate when the ray is transmitted through the second flat plate. In this case, a phase difference given by increasing the thickness of one flat plate in order to give the target relatively small predetermined phase difference to light and improve handlability can be offset by the other flat plate.

According to still another aspect of the invention, at least one of the first and second flat plate is arranged in contact with an optical element to be heated. In this case, it is possible to cool the optical element to be heated with the first flat plate or the second flat plate.

According to still another aspect of the invention, the optical element to be heated includes a polarizing film that transmits linear polarized light in a predetermined direction. In this case, it is possible to cool the polarizing film to be heated with the first flat plate or the second flat plate.

According to still another aspect of the invention, the first and second flat plates are formed of inorganic materials, respectively. In this case, it is possible to improve reliability concerning durability, accuracy, and the like of a device including the flat plates as a pair.

According to still another aspect of the invention, the first flat plate is formed of sapphire and the second flat plate is formed of crystal. In this case, it is possible to efficiently cool the optical element to be heated with sapphire and crystal usually having thermal conductivities higher than those of glass and quartz.

According to a specific aspect or viewpoint of the invention, in the projector, as a positional relation between the first and second flat plates, the first and second flat plates are in direct contact with each other, an isotropic medium is interposed between the first and second flat plates, or an anisotropic medium having an optical axis coinciding with the optical axes of the first and second flat plates are interposed between the flat plates.

According to still another aspect of the invention, the first and second flat plates are bonded via an adhesive. In this case, an optical element obtained by bonding the first and second flat plates functions as one phase difference plate. It is easy to build the optical element in the projector.

According to still another aspect of the invention, the optical device is a light modulator including a liquid crystal cell that holds liquid crystal and at least one polarizing member arranged near the liquid crystal cell. The first and second flat panels are arranged between the liquid crystal cell and the at lease one polarizing member. In this case, an optical device for light modulation that functions as a liquid crystal light bulb can be provided by the liquid crystal cell and at least one polarizing member. In the light modulator, i.e., the liquid crystal light bulb, it is possible to cause the flat plates to function as optical compensators against birefringence such as pre-tilt according to pseudo-birefringence using the first and second flat plates provided in the light modulator as a pair. The polarizing member means a polarizing element or a polarizing beam splitter.

According to still another aspect of the invention, the liquid crystal panel is arranged between the first flat plate and the second flat plate. An influence of birefringence of the liquid crystal panel is compensated for by the first and second flat plate. In this case, the liquid crystal cell to be compensated for by first and second substrates is arranged between the substrates. Thus, it is possible to accurately compensate for birefringence of the liquid crystal cell with birefringency of a pseudo thin film formed by the first and second substrates. It is possible to set, for example, light before incidence on the first substrate and light having passed through the second substrate in the same polarization state.

According to still another aspect of the invention, the optical device further includes an illuminating device that illuminates the light modulator and a projection lens that projects an image formed by the light modulator. In this case, it is possible to project image light formed by the light modulator, which is illuminated by the illuminating device, on a screen as an image through a projection lens.

### BRIEF DESCRIPTION OF THE DRAWINGS

The invention will be described with reference to the accompanying drawings, wherein like numbers reference like elements.

FIG. 1 is a side sectional view for explaining a structure of a liquid crystal panel according to a first embodiment of the invention.

FIG. 2 is a side view for explaining a structure of a first polarization filter.

FIG. 3 is a side view for explaining a structure of a second polarization filter.

FIGS. 4A and 4B are diagrams for explaining a refractive index of an optical compensator and an equivalent function of the optical compensator;

FIGS. 5A and 5B are diagrams for explaining a refractive index of a synthetic supporting plate and an equivalent function of the synthetic supporting plate.

FIG. 6 is a side sectional view for explaining a refractive index of a liquid crystal layer and a refractive index of the optical compensator.

FIGS. 7A and 7B are a side view and a plan view for explaining a refractive index of the liquid crystal layer, respectively.

FIGS. 8A and 8B are a side view and a plan view for explaining a refractive index of the optical compensator, respectively.

FIGS. 9A and 9B are diagrams showing tilt angle dependency of retardation and a weighting function of incident light, respectively.

FIG. 10A is a diagram showing an example concerning an angular field of view by a simulation.

FIGS. 10B and 10C are diagrams showing comparative examples concerning an angular field of view by a simulation.

FIG. 11 is a graph for explaining a result of the simulation.

FIG. 12 is a graph for explaining a result of another simulation.

FIG. 13 is a side sectional view for explaining a structure of a liquid crystal panel according to a second embodiment of the invention.

FIG. 14 is a diagram for explaining an optical system of a projector having a liquid crystal light bulb in FIG. 1 and the like built therein.

FIG. 15 is a side sectional view for explaining a liquid crystal light bulb according to a fourth embodiment of the invention.

FIG. 16 is a diagram for explaining an optical system of a projector having a liquid crystal light bulb in FIG. 15 built therein.

### DESCRIPTION OF EXEMPLARY EMBODIMENTS

### First Embodiment

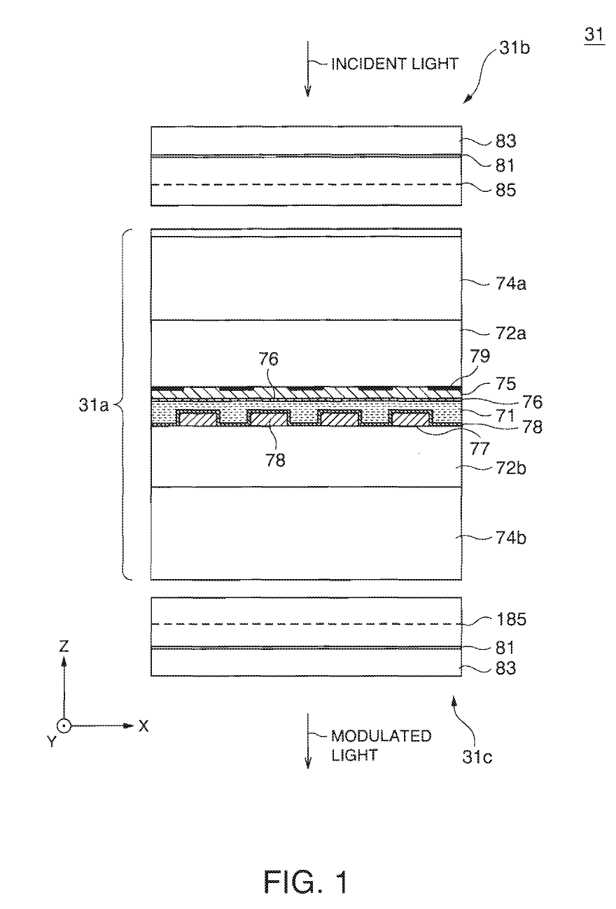

FIG. 1 is an enlarged sectional view for explaining a structure of a liquid crystal light bulb (a light modulator) serving as an optical device according to a first embodiment of the invention.

In a liquid crystal light bulb 31 shown in the figure, a first polarization filter 31b serving as a first sheet polarizer on an incidence side and a second polarization filter 31c serving as a second sheet polarizer on an emission side constitute a crossed Nichol prism. A liquid crystal device 31a placed between these first and second polarization filters 31b and 31c is a transmission liquid crystal panel that changes a polarization direction of incident light by a unit of pixel according to an input signal.

The liquid crystal device 31a includes a transparent first substrate 72a on the incidence side and a transparent second substrate 72b on the emission side across a liquid crystal layer 71 made of liquid crystal that operates in, for example, a vertical orientation mode (i.e., liquid crystal of a vertical orientation type). Moreover, the liquid crystal device 31a includes an incidence side cover 74a on an outer side of the first substrate 72a on the incidence side and includes an emission side cover 74b on an outer side of the second substrate 72b on the emission side.

A transparent common electrode 75 is provided on a surface on the liquid crystal layer 71 side of the first substrate 72a. For example, an orientation film 76 is formed on the common electrode 75. On the other hand, plural transparent pixel electrodes 77 arranged in a matrix shape and a thin-film transistor (not shown) electrically connected to the respective transparent pixel electrodes 77 are provided on a surface on the liquid crystal layer 71 side of the second substrate 72b. For example, an orientation film 78 is formed on the transparent pixel electrodes 77 and the thin-film transistor. The first and second substrates 72a and 72b, the liquid crystal layer 71 between the first and second substrates 72a and 72b, and the electrodes 75 and 77 form a liquid crystal cell for changing a polarization state of incident light. Each pixel forming the liquid crystal cell includes one pixel electrode 77, the common electrode 75, and the liquid crystal layer 71 placed between the pixel electrode 77 and the common electrode 75. A black matrix 79 of a lattice shape is provided between the first substrate 72a and the common electrode 75 to section respective pixels.

The orientation films 76 and 78 are films for arraying a liquid crystalline compound forming the liquid crystal layer 71. In an OFF state in which a voltage is not applied to the liquid crystal layer 71, the orientation films 76 and 78 have a function of orienting an optical axis off the liquid crystalline compound to be tilted at a not-large but uniform angle with respect to a normal of the first substrate 72a. In an ON state in which a voltage is applied to the liquid crystal layer 71, the orientation films 76 and 78 allow the optical axis of the liquid crystalline compound to be oriented in a specific direction (specifically, an X direction) perpendicular to the normal of the first substrate 72a. Consequently, in the OFF state in which a voltage is not applied to the liquid crystal layer 71, it is possible to secure a maximum light shielding state (a minimum luminance state). In the ON state in which a voltage is applied to the liquid crystal layer 71, it is possible to secure a maximum transmission state (a maximum luminance state).

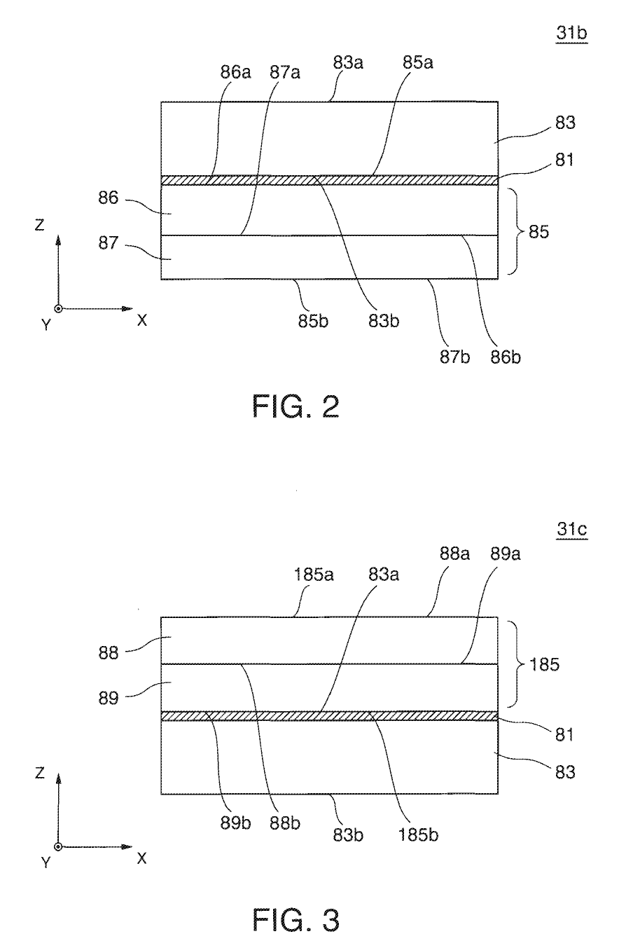

FIG. 2 is a sectional diagram for explaining a structure of the first polarization filter 31b arranged on the incidence side of the liquid crystal device 31a shown in FIG. 1. The first polarization filter 31b is a sheet polarizer, i.e., a polarizing element, of a three-layer structure including a polarizing film 81, an outer side supporting layer 83, and an optical compensator 85. The first polarization filter 31b is arranged in parallel to an XY plane perpendicular to a Z direction along an optical axis of incident light. The optical compensator 85 on an inner side is formed in a two layer structure including a first flat plate 86 and a second flat plate 87. As described in detail later, the flat plates 86 and 87 are formed of birefringent materials of kinds different from each other. All of an incidence plane 83a and an emission plane 83b of the outer side supporting layer 83 and an incidence plane 85a and an emission plane 85b of the optical compensator 85 are provided in parallel to one another. All of an incidence plane 86a and an emission plane 86b of the first flat plate 86 and an incidence plane 87a arid an emission plane 87b of the second flat plate 87 forming the optical compensator 85 are provided in parallel to one another. The incidence plane 86a of the first flat plate 86 and the emission plane 87b of the second flat plate 87 coincide with the incidence plane 85a and the emission plane 85b of the optical compensator 85 itself.

In the first polarization filter 31b, the polarizing film 81 as a polarizing member is held while being sandwiched between the outer supporting layer 83 formed of an organic material and the optical compensator 85 formed of an inorganic material. In other words, the optical compensator 85 not only compensates for phase shift remaining in the liquid crystal layer 71 when a voltage is not applied thereto but also acts as an inner side supporting layer that supports the polarizing film 81. The polarizing film 81 is a film for causing only linear polarized light oscillating in a fixed direction to pass. The polarizing film 81 is formed by, for example, absorbing a dye in a PVA (polyvinyl alcohol) film and extending the PVA film in a specific direction. The outer supporting layer 83 is formed of, for example, a thin TAC (triacetyle cellulose) plate. In the optical compensator 85, the first flat plate 86 is formed of a negative uniaxial refractive material (e.g., sapphire) and the second flat plate 87 is formed of a positive uniaxial refractive material (e.g., crystal). As a result, the optical compensator 85 functions as a negative uniaxial birefringent material as a whole using negative uniaxiality remaining after negative uniaxiality of the first flat plate 86 is offset by positive uniaxiality of the second flat plate 87. In other words, the optical compensator 85 has negative uniaxial birefringence as a pseudo refractive index.

Since the optical compensator 85 is in contact with the polarizing film 81, when the optical compensator 85 is formed of a crystalline inorganic material having a relatively high thermal conductivity such as sapphire or crystal and has relatively large thickness, it is possible to cause the optical compensator 85 to function as a kind of a cooling plate or a radiation plate that can efficiently cool the polarizing film 81 that easily generates heat by absorbing incident light.

FIG. 3 is a sectional diagram for explaining a structure of the second polarization filter 31c arranged on the emission side of the liquid crystal device 31a shown in FIG. 1. The second polarization filter 31c is a sheet polarizer, i.e., a polarizing element, of a three-layer structure including the polarizing film 81, the outer side supporting layer 83, and a synthetic supporting plate 185. The second polarization filter 31c is arranged in parallel to an XY plane perpendicular to a Z direction along an optical axis of modulated light. The synthetic supporting plate 185 is formed in a two layer structure including a first flat plate 88 and a second flat plate 89. The flat plates 88 and 89 are formed of birefringent materials of kinds different from each other. As in the case of the first polarization film 31b, all of the incidence plane 83a and the emission plane 83b of the outer side supporting layer 83 and an incidence plane 185a and an emission plane 185b of the synthetic supporting plate 185 are provided in parallel to one another. All of an incidence plane 88a and an emission plane 88b of the first flat plate 88 and an incidence plane 89a and an emission plane 89b of the second flat plate 89 forming the synthetic supporting plate 185 are provided in parallel to one another. The incidence plane 88a of the first flat plate 88 and the emission plane 89b of the second flat plate 89 coincide with the incidence plane 185a and the emission plane 185b of the synthetic supporting plate 185 itself.

In the second polarization filter 31c, the polarizing film 81 are the same as the polarizing film 81 and the outer side supporting layer 83 forming the first polarization filter 31b shown in FIG. 2. In the synthetic supporting plate 185 arranged on an inner side, the first flat plate 88 is formed of a negative uniaxial refractive material (e.g., sapphire) and the second flat plate 89 is formed of a positive uniaxial refractive material (e.g., crystal). As a result, in the synthetic supporting plate 185, negative uniaxiality of the first flat plate 88 is offset by positive uniaxiality of the second flat plate 89. The synthetic supporting plate 185 functions as a pseudo isotropic refractive material as a whole. In other words, the synthetic supporting plate 185 functions like an isotropic medium such as glass to transmit modulated light and hardly affects a polarization state of a light beam passing through the synthetic supporting plate 185.

Since the synthetic supporting plate 185 is in contact with the polarizing film 81, when the synthetic supporting plate 185 is formed of a crystalline inorganic material having a relatively high thermal conductivity such as sapphire or crystal and has relatively large thickness, it is possible to cause the synthetic supporting plate 185 to function as a kind of a cooling plate or a radiation plate that can efficiently cool the polarizing film 81 that easily generates heat by absorbing modulated light.

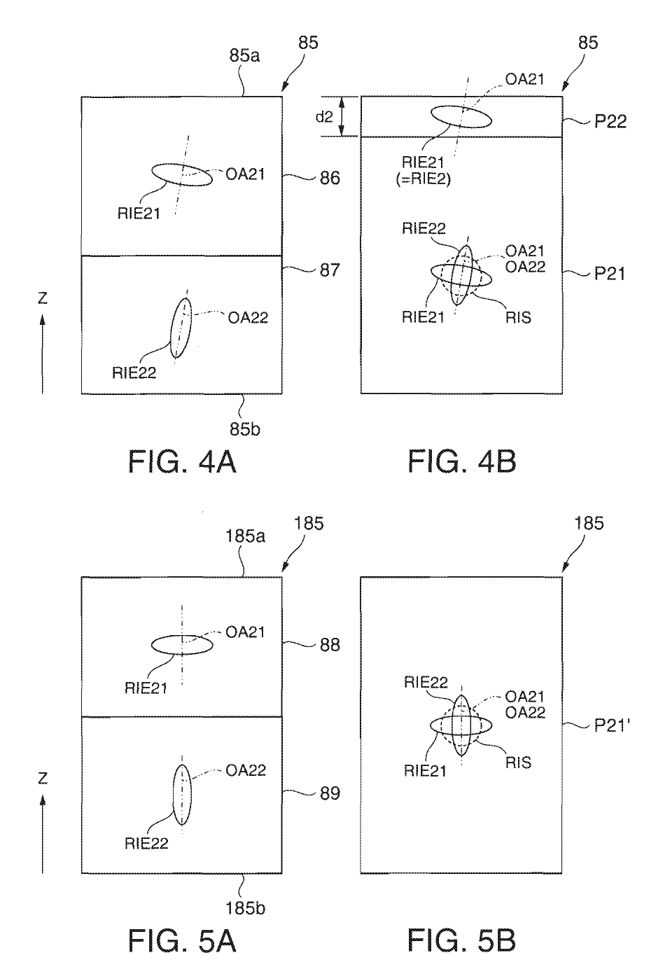

FIG. 4A is a side view for explaining a refractive index of the optical compensator 85 incorporated in the first polarization filter 31b should in FIG. 2. FIG. 4B is a diagram for explaining an equivalent function of the optical compensator 85. In the optical compensator 85, a minor axis, i.e., an optical axis OA21, of a refractive index ellipsoid RIE21 of the negative uniaxial refractive material forming the first flat plate 86 is substantially perpendicular to but is arranged to be tilted at a very small angle with respect to the incidence plane 85a and the emission plane 85b. A major axis, i.e., an optical axis OA22, of a refractive index ellipsoid RIE22 of the positive uniaxial refractive material forming the second flat plate 87 is also substantially perpendicular to but is arranged to be tilted at the very small angle with respect to the incidence plane 85a and the emission plane 85b. The optical axis OA22 is parallel to the optical axis OA21 of the refractive index ellipsoid RIE21. As a result, the optical axes OA21 and OA22 of the flat plates 86 and 87, i.e., an optical axis of the optical compensator 85, is tilted at the very small angle with respect to the normal of the incidence plane 85a. Consequently, according to a tilt angle of the optical axes OA21 and OA22 of the optical compensator 85 with respect to a main beam of an illuminating light beam made incident on the incidence plane 85a (in the example shown in the figure, extending in the Z direction along the normal of the incidence plane 85a), a phase difference given to the illuminating light beam changes. In other words, the phase difference decreases as the optical axes OA21 and OA22 of the optical compensator 85 are closer to parallel to the main beam of the illuminating light beam (in this case, extending in the Z direction) and the phase difference increases as the optical axes OA21 and OA22 are closer to vertical. The tilt angle of the optical axes OA21 and OA22 of the optical compensator 85 with respect to the main beam of the illuminating light beam is appropriately set according to a purpose of use of the optical compensator 85.

As shown in FIG. 4B, the optical compensator 85 can be divided into a first section P21 and a second section P22 for consideration. The first section P21 can be regarded as being formed by combining the refractive index ellipsoid RIE21 and the refractive index ellipsoid RIE22 to be offset at an appropriate ratio. The first section P21 functions as an isotropic medium equivalent to a refractive index sphere RIS and does not give a phase difference to incident light. The second section P22 can be regarded as an extremely thin layer that is the first flat plate 86 partially remaining without losing the effect of giving a phase difference. It is possible to give a phase difference to incident light using the refractive index ellipsoid RIE21 of this extremely thin layer. In other words, by bringing the optical compensator 85 into an unbalanced state appropriately shifted from an isotropic state in which the thickness of the first flat plate 86 and the thickness of the second flat plate 87 are balanced, it is possible to obtain the optical compensator 85 that functions as a negative uniaxial birefringent material having an optical axis parallel to the optical axis OA21 and has a small phase giving amount, i.e., a compensation amount, as a whole.

In the above explanation, it is assumed that the first flat plate 86 and the second flat plate 87 have substantially identical refractive indexes. However, when a refractive index difference between the flat plates 86 and 87 is large, taking into account refraction in a boundary of the flat plates 86 and 87, tilt angles of the optical axes OA21 and OA22 of the flat plates 86 and 87 and the thicknesses of the flat plates 86 and 87 are adjusted. Consequently, it is possible to cause light passing through the first flat plate 86 in parallel to the optical axis OA21 to pass through the second flat plate 87 in parallel to the optical axis OA22. It is possible to give a desired phase difference to transmitted light.

FIG. 5A is a side view for explaining a refractive index of the synthetic supporting plate 185 incorporated in the second polarization filter 31c shown in FIG. 3. FIG. 5B is a diagram for explaining an equivalent function of the synthetic supporting plate 185. In the synthetic supporting plate 185, a minor axis, i.e., the optical axis OA21, of the refractive index ellipsoid RIE21 of the negative uniaxial refractive material forming the first flat plate 88 is arranged to be perpendicular to the incidence plane 185a and the emission plane 185b. A major axis, i.e., the optical axis OA22, of the refractive index ellipsoid RIE22 of the positive uniaxial refractive material forming the second flat plate 89 is also arranged to be perpendicular to the incidence plane 185a and the emission plane 185b. The optical axis OA22 is parallel to the optical axis OA21 of the refractive index ellipsoid RIE21. As a result, the synthetic supporting plate 185 can be regarded as an optical member P21′ obtained by combining the refractive index ellipsoid RIE21 and the refractive index ellipsoid RIE22 at an appropriate ratio to offset each other. The synthetic supporting plate 185 functions as an isotropic medium equivalent to the refractive index sphere RIS and does not give a phase difference to incident light. In other words, by bringing the synthetic supporting plate 185 into a state in which the thickness of the first flat plate 88 and the thickness of the second flat plate 89 are balanced, it is possible to obtain the synthetic supporting plate 185 that functions as an isotropic reflective material and hardly generate a phase as a whole.

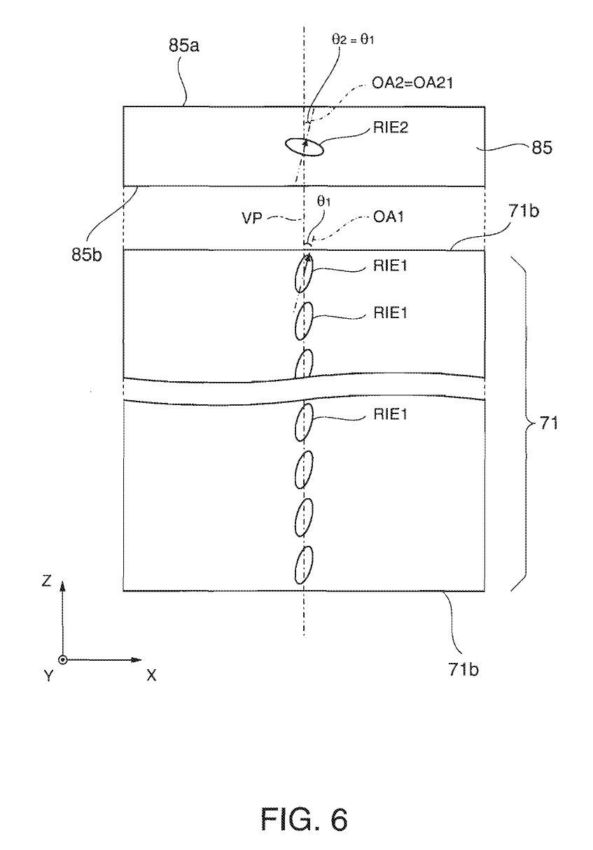

FIG. 6 is a conceptual diagram of a side section for explaining a relation between a refractive index of the liquid crystal layer 71 and a pseudo refractive index of the optical compensator 85. All incidence surface 71a and an emission surface 71b of the liquid crystal layer 71 are parallel to each other. An incidence plane 85a and an emission plane 85b of the optical compensator 85 are arranged to be parallel to the incidence surface 71a of the liquid crystal layer 71. In other words, an optical path VP of a light beam vertically made incident on the incidence surface 71a of the liquid crystal layer 71 is also made vertically incident on the incidence plane 85a of the optical compensator 85 and vertically emitted from the emission surface 85b.

In the liquid crystal layer 71, the major axis, i.e., an optical axis OA1, of the refractive index ellipsoid RIE1 of the liquid crystalline compound in the OFF state not applied with an electric field has a small but fixed tilt angle with respect to a Z axis in an XZ plane. In this case, a tilting direction of a refractive index ellipsoid RIE1 is an X direction. This X direction is referred to as an orientation direction of the liquid crystal layer 71. A tilt angle in the orientation direction of the refractive index ellipsoid RIE1 is referred to as a pre-tilt angle θ1. On the other hand, in the optical compensator 85, a refractive index ellipsoid RIE2 equivalent to a pseudo refractive index of the optical compensator 85 is equivalent to the refractive index ellipsoid RIE21 of the negative uniaxial crystal shown in FIGS. 4A and 4B. A minor axis, i.e., an optical axis OA2, of the refractive index ellipsoid RIE2 has a small but fixed tilt angle with respect to the Z axis in the XZ plane. More specifically, a tilting direction, i.e., an azimuth angle, of the refractive index ellipsoid RIE2 is the X direction, which is the same as the orientation direction of the liquid crystal layer 71. A tilt angle θ2 in the azimuth angle at which the refractive index ellipsoid RIE2 tilts is equal to the pre-tilt angle θ1 given to the liquid crystal layer 71 with the optical path VP of the incident light vertical made incident on the incidence surface 71a as a reference. In other words, concerning a beam made incident on the liquid crystal device 31a at a certain incidence angle, when the beam is transmitted through the optical compensator 85 and when the beam is transmitted through the liquid crystal layer 71, by adjusting the optical axis OA2 (=OA21) in the optical compensator 85, the beam is adjusted such that light passing through the liquid crystal layer 71 in parallel to the optical axis OA1 passes through the optical compensator 85 in parallel to the optical axis OA2.

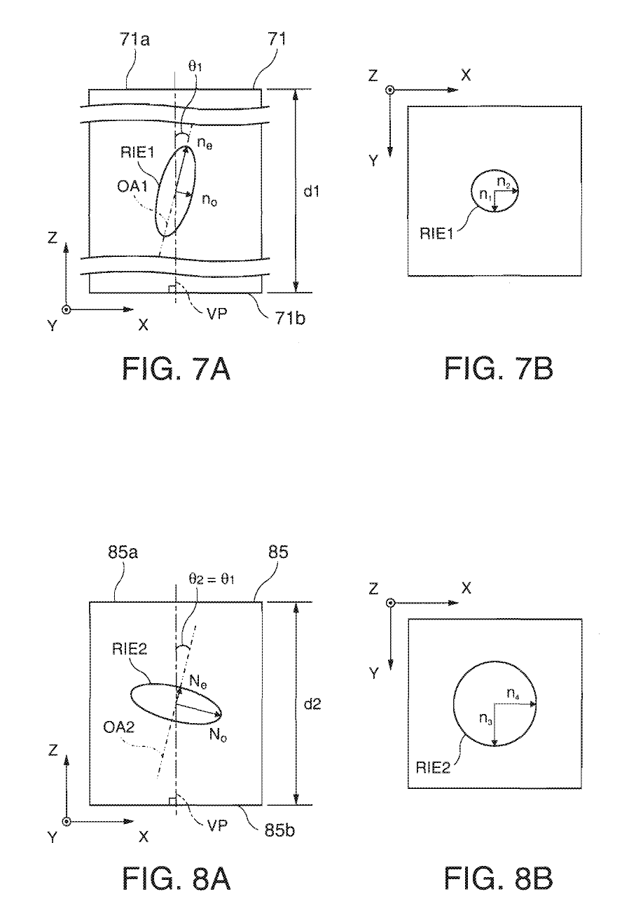

FIG. 7A is a side view for explaining a refractive index of the liquid crystal layer 71. FIG. 7B is a plan view for explaining a refractive index of the liquid crystal layer 71. FIG. 8A is a side view or explaining a pseudo refractive index of the optical compensator 85. FIG. 8B is a plan view for explaining a pseudo refractive index of the optical compensator 85.

First, concerning the liquid crystal layer 71, the refractive index ellipsoid of the liquid crystalline compound is equivalent to the positive uniaxial material. When refractive indexes in respective axial directions with a refractive index of the positive uniaxial material set as a reference is nx, ny, and nz, in general, a relation of nx=ny<nz holds. The optical axis OA1 corresponding to a major axis of the refractive index nz is tilted by the pre-tilt angle θ1 with respect to the optical path VP of the beam made incident on the incidence surface 71a of the liquid crystal layer 71 from a direction of the normal (vertically incident light). When, as shown in FIG. 7A, a normal refractive index is nₒ and an abnormal refractive index is nₑ, i.e., nx=ny=nₒ and nz=nₑ and, as shown in FIG. 7B, a refractive index concerning light oscillating in a phase delay axis direction of the vertically incident light is n₂ and a refractive index concerning light oscillating in a phase advance axis direction is n₁, the following equations hold.

$$\begin{matrix}{n}_{1} = {n}_{0} & ( 1 ) \\ {n}_{2} = \frac{{n}_{e} {n}_{o}}{\sqrt{{n}_{e}^{2} {cos}^{2} ( θ 1 ) + {n}_{o}^{2} {sin}^{2} ( θ 1 )}} & ( 2 )\end{matrix}$$

### Thus, retardation Re1 of the liquid crystal layer 71 with respect to the vertically incident light is represented by the following equation with an effective thickness of the liquid crystal layer 71 set as d1.

$$\begin{matrix}Re 1 = ( {n}_{2} - {n}_{1} ) \times d 1 \\ = ( \frac{{n}_{e} {n}_{o}}{\sqrt{{n}_{e}^{2} {cos}^{2} ( θ 1 ) + {n}_{o}^{2} {sin}^{2} ( θ 1 )}} - {n}_{0} ) \times d 1\end{matrix} \qquad ( 3 )$$

Similarly, concerning the optical compensator 85, this optical compensator 85 is simulatively made of a negative uniaxial material equivalent to the refractive index ellipsoid RIE2. When refractive indexes in respective axial directions with respect to a refractive index of the negative uniaxial material is nx, ny, and nz, in general, a relation of nx=ny>nz holds. The optical axis OA2 corresponding to a minor axis of the refractive index nz is tilted by the tilt angle θ2=θ1 with respect to the optical path VP of the vertically incident light made incident on the incidence surface 71a of the liquid crystal layer 71 from the direction of the normal. When, as shown in FIG. 8A, a normal refractive index is Nₒ and an abnormal refractive index is Nₑ and, as shown in FIG. 8B, a refractive index concerning light oscillating in a phase advance axis direction of the vertically incident light is n₄ and a refractive index concerning light oscillating in a phase delay axis direction is n₃, the following equations hold.

$$\begin{matrix}{n}_{3} = {N}_{0} & ( 4 ) \\ {n}_{4} = \frac{{N}_{e} {N}_{o}}{\sqrt{{N}_{e}^{2} {cos}^{2} ( θ 2 ) + {N}_{o}^{2} {sin}^{2} ( θ 2 )}} & ( 5 )\end{matrix}$$

### Thus, retardation Re2 of the optical compensator 85 with respect to the vertically incident light is represented by the following equation with an effective thickness of the optical compensator 85 set as d2.

$$\begin{matrix}Re 2 = ( {n}_{3} - {n}_{4} ) \times d 2 \\ = ( {N}_{0} - \frac{{N}_{e} {N}_{o}}{\sqrt{{N}_{e}^{2} {cos}^{2} ( θ 2 ) + {N}_{o}^{2} {sin}^{2} ( θ 2 )}} ) \times d 2\end{matrix} \qquad ( 6 )$$

The major axis having the refractive index nz of the liquid crystal layer 71 and the minor axis having the refractive index nz of the optical compensator 85 are arranged in parallel to each other and phase delay axes and phase advance axes of the liquid crystal layer 71 and the optical compensator 85 are interchanged. Therefore, total retardation RE with respect to the vertically incident light is given as an absolute value of a difference between Re1 given by Equation (3) and Re2 given by Equation (6). When Re1=Re2, polarized light emitted from the second polarization filter 31a and polarized light incident to the first polarization filter 31b are in an identical state. Light shielding by the second polarization filter 31c against the vertically incident light is perfect. Contrast of an image determined by transmission and light shielding by the liquid crystal light bulb 31 is maximized.

In the following explanation, incident light on the liquid crystal light bulb 31 has an angular distribution. First, a light beam made obliquely incident on the liquid crystal light bulb from the air will be considered. A tilt angle of tilted light (obliquely incident light) with respect to the optical path VP of the vertically incident light in the air is set as η0, a tilt angle of tilted light with respect to the optical path VP of the vertically incident light in the optical compensator 85 is set as η1, and a tilt angle of tilted light with respect to the optical path VP of the vertically incident light in the liquid crystal layer 71 is set as η2. In this case, in the optical compensator 85 (in particular, the first flat plate 86), since a difference between Nₒ and Nₑ is small, Nₒ=Nₑ. Thus, the light beam made incident on the optical compensator 85 from the air at the tilt angle of η0 follows an optical path that satisfies the following condition when a tilting direction of the incident light beam is also taken into account.

sin(η0) :sin(η1)=1:1/Nₒ

sin(η1)=sin(η0)/Nₒ (7)

### Moreover, in the liquid crystal layer 71, since nₒ=nₑ, the light beam made incident on the liquid crystal layer 71 through the optical compensator 85 follows an optical path that satisfies the following condition.

sin(η0) :sin(η2)=1:1/Nₒ

sin (η2)=sin(η0)/Nₒ (8)

In the above explanation, the light beam made incident at the tilt angle η0 with respect to the optical path VP of the vertically incident light is considered. However, a refractive index effect at the time when the incident light beam passes through the liquid crystal layer 71 and the optical compensator 85 depends on a tilting direction of the incident light beam. Here, taking into account the tilting direction of the incident light beam, the tilt angle η0 of the incident light beam is set as a polar angle and an azimuth angle of the incident light beam is set as φ. In this case, it is possible to geometrically calculate an angle w1 formed by the light beam passing through the liquid crystal light bulb 31 and the optical axis OA1 in the optical compensator 85 and an angle w2 formed by the light beam and the optical axis OA2 in the liquid crystal layer 71 from the variables η0 and φ and η1 and η2 obtained on the basis of the variables. Retardation Re′ at the time when such tilted light passes through the optical compensator 85 and the liquid crystal layer 71 is given by the following equation.

$${Re}^{′} = \vert \begin{matrix}( {N}_{0} - \frac{{N}_{e} {N}_{o}}{\sqrt{{N}_{e}^{2} {cos}^{2} ( w 1 ) + {N}_{o}^{2} {sin}^{2} ( w 1 )}} ) \times \frac{d 2}{cos ( η 2 )} - \\ ( \frac{{n}_{e} {n}_{o}}{\sqrt{{n}_{e}^{2} {cos}^{2} ( w 2 ) + {n}_{o}^{2} {sin}^{2} ( w 2 )}} - {n}_{0} ) \times \frac{d 1}{cos ( η 1 )}\end{matrix} \vert \qquad ( 9 )$$

### In the above equation, d2/cos η2 is an effective thickness of the tilted incident light in the optical compensator 85 and d1/cos η1 is an effective thickness of the tilted incident light in the liquid crystal layer 71.

As a result, the refractive indexes nₒ, nₑ, Nₒ, Nₑ, d1, d2, and β are constants and values η1, η2, w1, and w2 are parameters determined by the variables η0 and φ, the retardation Re′ at the time when the light beam passes through the liquid crystal light bulb 31 and the optical compensator 85 can be considered as the following function f and processed.

Re′=f(η0,φ) (10)

Thus, it is also possible to calculate, on the basis of Equation (10), the retardation Re′ for all incident rays and optimize the effective thickness d2 of the optical compensator 85 such that a sum of the retardation Re′ is a minimum value. In this case, contrast of an image determined by transmission and light shielding of the liquid crystal light bulb 31 is maximized. For example, in the case of a light beam vertically made incident on the liquid crystal light bulb 31 at fixed NA, η0 corresponding to an opening angle is 0 to η max and the azimuth angle φ is 0 to 360°. Thus, the optical compensator 85 is set such that the following integrated value is closer to zero.

$${\int }_{0}^{η max} {\int }_{0}^{360} \vert f ( η 0 , φ ) \times W ( η 0 , φ ) \vert d φ d η 0 \qquad ( 11 )$$

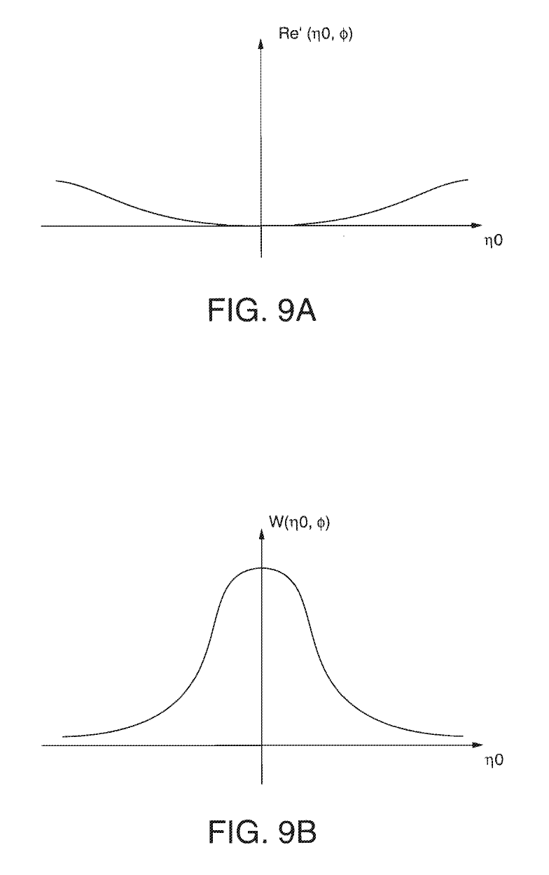

W (η0,φ) is a weighting function given by an angular distribution of incident light. FIG. 9A is a diagram for visually explaining a relation between the retardation Re′=f(η0,φ) of passing light and the tilt angle η0 in the case in which φ deviates from the tilting direction by 90°. The retardation Re′ is the smallest for light in a front direction in which the tilt angle η0 is 0. As the tilt angle η0 increases, the retardation Re′ gradually increases. FIG. 9B is a diagram for visually explaining a relation between the weighting function W(η0,φ) of the incident light and the tilt angle η0. The density of light in the front direction in which the tilt angle η0 is 0 is the highest and the weighting function takes a maximum value according to the density of light. The above explanation is only an example. A characteristic of the retardation Re′=f(η0,φ) depends on optical characteristics of the liquid crystal layer 71 and the optical compensator 85. W(η0,φ) depends on a radiation characteristic of a light source, an optical characteristic of an equalizing optical system, a characteristic of a microlens of liquid crystal, and the like. In other words, by adjusting the refractive index ellipsoid RIE2 and the effective thickness d2 of the optical compensator 85, it is possible to minimize an integrated value of the retardation Re′=f(η0,φ) with respect to illuminating devices having various kinds of W(η0,φ) and set contrast of image formed by the liquid crystal light valve 31 extremely high.

It is possible to quickly calculate an integrated value (total retardation) represented by Equation (11) according to a simulation for performing a high-speed arithmetic operation. It is possible to quickly determine the effective thickness d2 and the tilt angle θ2 of the optical compensator 85 by inputting a characteristic of the liquid crystal layer 71 and a refractive index characteristic of the optical compensator 85.

In the above explanations the refractive index ellipsoid RIE2 of the optical compensator 85 forming the polarization filter 31b is fixed. However, considering the fact that the optical compensator 85 includes the first and second flat plates 86 and 87, it is desirable to take into account the tilting direction and the angular distribution of the incident light beam in the flat plates 86 and 87. In other words, it is desirable to determine the retardation Re2 from optical paths in the respective flat plates 86 and 87 forming the optical compensator 85 taking into account the tilt angle η0 of the incident light beam and determine the total retardation Re′ taking into account the weighting function W(η0,φ) of the light source including the liquid crystal layer 71. Consequently, it is possible to further improve contrast of the liquid crystal light bulb 31.

In the above explanation, in the polarization filters 31b and 31c, the polarizing film 81 is a polarizer of an absorption type formed of resin or the like. However, the polarizing film 81 may be a polarizer of a reflection type such as a wire grid polarizer.

Specific examples will be hereinafter explained. As the optical compensator 85 for compensating for phase shift remaining in various liquid crystal layers 71 of the vertical orientation type incorporating the optical bonding the first flat plate 86 made of sapphire and the second flat plate 87 made of crystal was obtained. The thickness of the first flat plate 86 was set in a range of, for example, about 100 to 1000 μm taking into account machinability and the thickness of the second flat plate 87 was set in a range of, for example, about 100 to 1000 μm taking into account machinability.

A simulation was performed concerning the liquid crystal light bulb 31 including the liquid crystal layer 71 of the vertical orientation type of a certain type and incorporating the optical compensator 85. In this case, pre-tilt of the liquid crystal layer 71 was set to 4° and a cell gap thereof was set to 2.5 μm. Thickness d21 of the first flat plate 86 made of sapphire and thickness d22 of the second flat plate 87 made of crystal forming the optical compensator 85 were changed to satisfy, for example, a relation d21:s22=1:1.45. As a result, effective thickness d2=50 μm of the optical compensator 85 was an optimum value and the integrated value given by Equation (11) could be set as a minimum value.

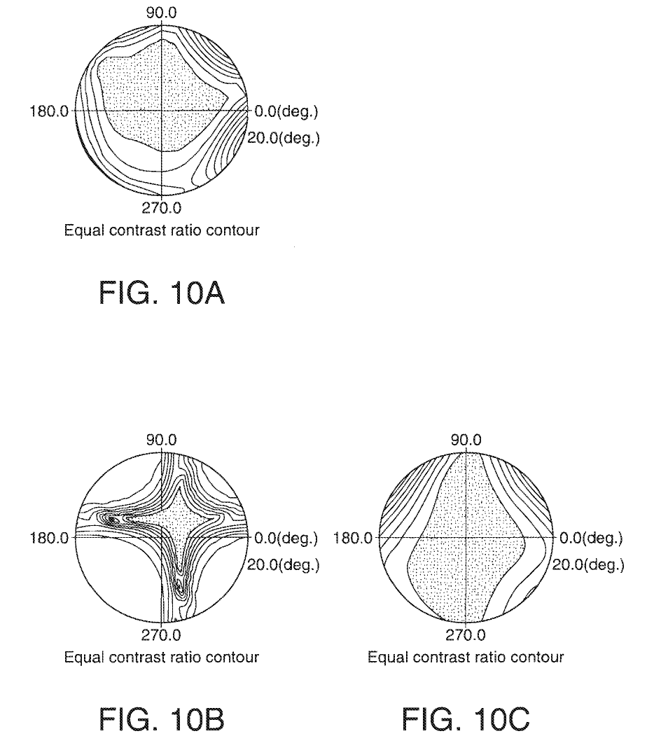

FIGS. 10A to 10C are diagrams showing results obtained by performing a simulation using data corresponding to the specific liquid crystal light bulb 31. FIG. 10A shows an angular field of view characteristic of the liquid crystal light bulb 31 of the example incorporating the optical compensator 85 obtained by bonding a sapphire plate having the thickness of 700 μm and a crystal plate having the thickness of 445 μm. FIG. 10B shows an angular field of view characteristic of a liquid crystal light bulb of a comparative example in which the optical compensator 85 is not provided. FIG. 10C shows an angular field of view characteristic of a liquid crystal light bulb of a comparative example incorporating the optical compensator 85 made of an independent sapphire plate having the thickness of 50 μm. As it is seen when FIG. 10A and FIG. 10C are compared, an angular field of view characteristic of a degree equivalent to that of the independent sapphire plate is obtained by bonding the sapphire plate and the crystal plate. This means that 650 μm of the thickness 700 μm of the sapphire plate is offset by the thickness 445 μm of the crystal plate and, as a result, a phase effect is attained as if an independent sapphire plate having the thickness of 53 μm is provided and a compensation effect of a degree same as that of the sapphire plate having the thickness of 50 μm is attained by the optical compensator 85 in the liquid crystal light bulb 31.

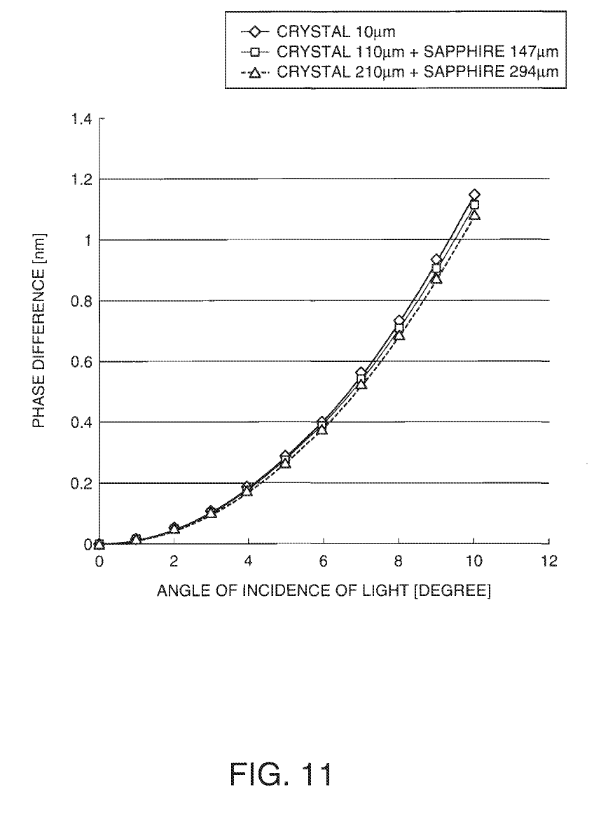

FIG. 11 is a graph of a result obtained by checking a phase difference in the case in which the thickness of the first flat plate 86 and the thickness of the second flat plate 87 forming the optical compensator 85 are changed. In the graph, a square mark indicates dependency on an angle of incidence of a phase difference of the optical compensator 85 in the case in which the first flat plate 86 made of sapphire having the thickness of 147 μm and the second flat plate 87 made of crystal having the thickness of 110 μm are bonded. A triangle mark indicates dependency on an angle of incidence of a phase difference of the optical compensator 85 in the case in which the first flat plate 86 made of sapphire having the thickness of 294 μm and the second flat plate 87 made of crystal having the thickness of 210 μm are bonded. A diamond mark indicates dependency on an angle of incidence of a phase difference of the optical compensator 85 in which crystal having the thickness of 10 μm is independently used in a comparative example. As it is evident from the graph, it is seen that, in a range in which an angle of incidence is equal to or smaller than 10°, dependency on an angle of incidence of a phase difference hardly occurs and is in no way inferior to that of the optical compensator 85 in which crystal having the thickness of 10 μm is independently used. In other words, by combining the first flat plate 86 made of sapphire and the second flat plate 87 made of crystal, it is possible to relatively easily obtain the optical compensator 85 that simulatively has negative uniaxiality and can compensate for a phase difference in a three-dimensional angle range. Such an optical compensator 85 and the flat plates 86 and 87 forming the optical compensator 85 are relatively thick. Thus, machining of the flat plates 86 and 87 is easy and handling of the optical compensator 85 is also easy.

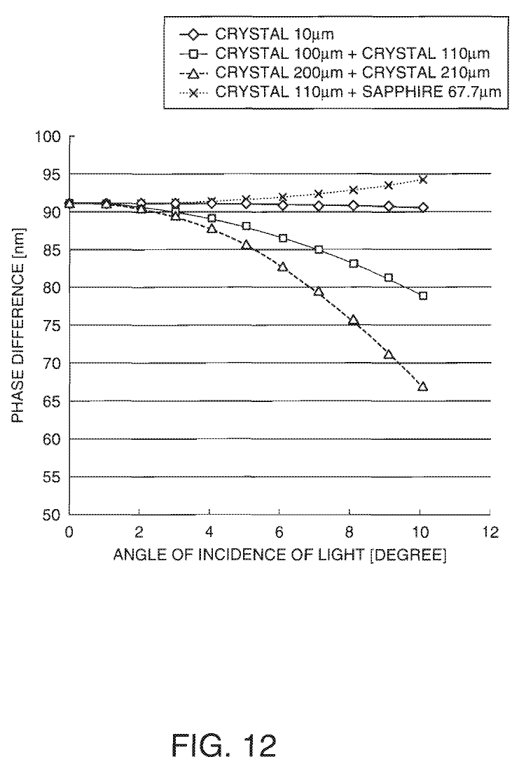

FIG. 12 is a graph of a result obtained by checking a phase difference in the case in which the thickness of the first flat plate 86 and the thickness of the second flat plate 87 forming the optical compensator 85 are changed under another condition. In this case, the second flat plate 87 is considerably thicker than the first flat plate 86. The optical compensator 85 simulatively functions as a positive uniaxial crystal. In the graph, an X mark indicates dependency on an angle of incidence of a phase difference of the optical compensator 85 in the case in which the first flat plate 86 made of sapphire having the thickness of 67.7 μm and the second flat plate 87 made of crystal having the thickness of 110 μm are bonded. A diamond mark indicates dependency on an angle of incidence of a phase difference of the optical compensator 85 in which crystal having the thickness of 10 μm is independently used in a comparative example. A square mark indicates dependency on an angle of incidence of a phase difference of the optical compensator 85 of a comparative example in the case in which the first flat plate 86 made of crystal having the thickness of 100 μm, an optical axis of which is parallel to an incidence surface and the second flat plate 87 made of crystal having the thickness of 110 μm, an optical axis of which is perpendicular to the incidence surface, are bonded. In this case, positive uniaxial crystals perform optical compensation each other. A triangle mark indicates dependency on an angle of incidence of a phase difference of the optical compensator 85 of a comparative example in the case in which the first flat plate 86 made of crystal having the thickness of 200 μm, an optical axis of which is parallel to an incidence surface, and the second flat plate 87 made of crystal having the thickness of 210 μm, an optical axis of which is perpendicular to the incidence surface, are bonded. In this case, as in the above case, positive uniaxial crystals perform optical compensation each other. As it is evident from above, it is seen that, according to the combination of a sapphire plate and a crystal plate, a phase difference is maintained at a phase difference equivalent to that in the case in which the crystal plate is independently used if an angle of incidence is about 10° and, compared with the case in which a pair of crystal plates are combined, extremely low dependency on an angle of incidence is attained.

A method of manufacturing the first polarization filer 31b including the optical compensator 85 will be hereinafter explained. First, a PVA film is bonded to a TAC plate, which should be formed as the outer side supporting layer 83, via an adhesive. A dye mainly containing iodine and the like is absorbed in the PVA film to dye the PVA film. Thereafter, the PVA film is extended together with the TAC plate to give a desired polarization characteristic to the PVA film. Consequently, a two layer structure of the polarizing film 81 and the outer side supporting layer 83 is obtained. In parallel with this, a material of the optical compensator 85 is prepared. A sapphire plate as a material of the first flat plate 86 and a crystal plate as a material of the second flat plate 87 are sliced with thickness larger than a target thickness by thickness for grinding such that a tilting direction (an orientation direction) of the refractive index ellipsoids RIE21 and RIE22 are at a substantially identical tilt angle with respect to a pair of opposed planes, i.e., principal planes of the flat plates 86 and 87. Subsequently, machining such as grinding is applied to the pair of opposed surfaces of the sapphire plate and the crystal plate to smooth the surfaces. After bonding the sapphire plate and the crystal plate after cleaning via an ultraviolet curing resin in a state in which tilting directions (azimuth angles) of optical axes of both the plates are set in the same direction, the sapphire plate and the crystal plate are fixed by hardening. Finally, after bonding the two layer structure of the polarizing film 81 and the outer side supporting layer 83 separately prepared and the optical compensator 85 made of the sapphire plate and the crystal plate via the ultraviolet curing resin, the two layer structure and the optical compensator 85 are fixed by hardening.

### Second Embodiment

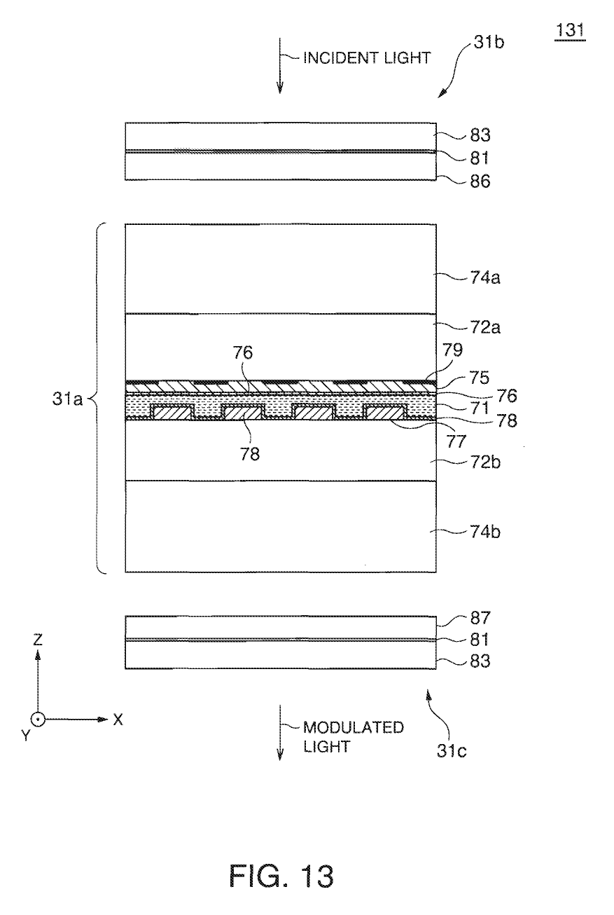

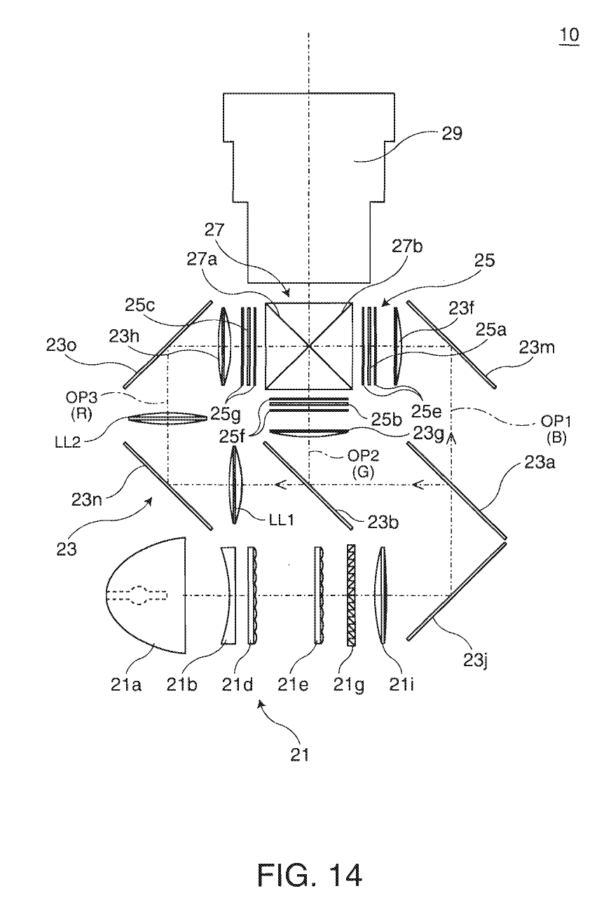

FIG. 13 is a diagram showing a liquid crystal light bulb according to a second embodiment of the invention, which is a modification of the liquid crystal light bulb 31 shown in FIG. 1. In the case of this liquid crystal light bulb 131, only the first flat plate 86 of the optical compensator 85 (see FIG. 1) is arranged on the light incidence side of the liquid crystal device 31a and the light emission side of the first polarization filter 31b. The second flat plate 87 of the optical compensator 85 is arranged on the light emission side of the liquid crystal device 31a and the light incidence side of the second polarization filter 31c. In this embodiment, the first flat plate 86 is bonded to the light emission side surface of the first polarization filter 31b and the second flat plate 87 is bonded to the light incidence side surface of the second polarization filter 31c. The synthetic supporting plate 185 (see FIG. 1) of the second polarization filter 31c in the first embodiment is replaced with the second flat plate 87. The first flat plate 86 and the second flat plate 87 are separated but have a function identical with that of the optical compensator 85 shown in FIG. 1. In other words, when both the optical axes OA21 and OA22 of both the flat plates 86 and 87 coincide with the tilt (pre-tilt) of the optical axis OA1 during a necessary operation (e.g., during off time) of the liquid crystal layer 71, it is possible to arrange the flat plates 86 and 87 on both sides of the liquid crystal layer 71, separately. Consequently, the first flat plate 86 and the second flat plate 87 act as the optical compensator 85 that compensates for a phase difference of the liquid crystal layer 71 and can also function as a supporting plate for the first polarization filter 31b and the second polarization filter 31c.

### Third Embodiment

FIG. 14 is a diagram for explaining a structure of an optical system of a projector incorporating the liquid crystal light bulb 31 shown in FIG. 1.

This projector 10 includes a light source device 21 that generates light source light, a color-separation optical system 23 that divides the light source light into three colors of red, green, and blue, a light modulating unit 25 that is illuminated by illumination lights of the respective colors emitted from the color-separation optical system 23, a cross dichroic prism 27 that combines image lights of the respective colors from the light modulating unit 25, and a projection lens 29 as a projection optical system for projecting light transmitted through the cross dichroic prism 27 on a screen (not shown). The light source device 21, the color-separation optical system 23, the light modulating unit 25, and the cross dichroic prism 27 constitute an image forming apparatus that forms image light that should be projected on the screen.

In the projector 10, the light source device 21 includes a light source lamp 21a, a concave lens 21b, a pair of fly-eye optical systems 21d and 21e, a polarization converting member 21g, and a superimposing lens 21i. The light source lamp 21a is made of, for example, a high-pressure mercury lamp and includes a concave mirror that collects the light source light and emits the light forward. The concave lens 21b has a role of collimating the light source light from the light source lamp 21a. However, the concave lens 21b may be omitted. The pair of fly-eye optical systems 21d and 21e include plural element lenses arranged in a matrix shape. The pair of fly-eye optical systems 21d and 21e divide the light source light from the light source lamp 21a through the concave lens 21b and condense or diverge the divided light individually using these element lenses. The polarization converting member 21g converts the light source light emitted from the fly-eye optical system 21e into only an S polarized light component perpendicular to the paper surface in FIG. 13 and supplies the light to the optical system at the next stage. The superimposing lens 21i appropriately converges the illuminating light transmitted through the polarization converting member 21g as a whole to make it possible to perform superimposed lighting on the light modulators of the respective colors provided in the light modulating unit 25. In other words, the illuminating light transmitted through the fly-eye optical systems 21d and 21e and the superimposing lens 21i is transmitted through the color-separation optical system 23 described below in detail and uniformly illuminates liquid crystal panels 25a, 25b, and 25c of the respective colors provided in the light modulating unit 25 in a superimposing manner.

The color-separation optical system 23 includes first and second dichroic mirrors 23a and 23b, three field lenses 23f, 23g, and 23h as correction optical systems, and reflection mirrors 23j, 23m, 23n, and 23o. The color-separation optical system 23 constitutes an illuminating device together with the light source device 21. Among red, green, and blue lights, the first dichroic mirror 23a reflects, for example, the red light and the green light and transmits the blue light. The second dichroic mirror 23b reflects, for example, the green light and transmits the red light of the red light and the green light made incident thereon. In this color-separation optical system 23, the light source light of a substantially white color from the light source device 21 has an optical path thereof bent by the reflection mirror 23j and is made incident on the first dichroic mirror 23a. The blue light having passed through the first dichroic mirror 23a is made incident on the field lens 23f through the reflection mirror 23m while keeping, for example, the state of the S polarized light. The green light reflected by the first dichroic mirror 23a and further reflected by the second dichroic mirror 23b is made incident on the field lens 23g while keeping, for example, the state of the S polarized light. The red light having passed through the second dichroic mirror 23b is made incident on the field lens 23h for adjusting an angle of incidence through lenses LL1 and LL2 and the reflection mirrors 23n and 23o while keeping, for example, the state of the S polarized light. The lenses LL1 and LL2 and the field lens 23h constitute a relay optical system. This relay optical system has a function of substantially directly transmitting an image of the first lens LL1 to the field lens 23h via the second lens LL2.

The light modulating unit 25 includes three liquid crystal panels 25a, 25b, and 25c and three pairs of polarization filters 25e, 25f, and 25g arranged to sandwich the liquid crystal panels 25a, 25b, and 25c, respectively. The liquid crystal panel 25a for blue light arranged in a first optical path OP1 and the pair of polarization filters 25e, 25e sandwiching the liquid crystal panel 25a constitute a liquid crystal light bulb for the blue color for two-dimensionally subjecting the blue light to luminance modulation on the basis of image information. The liquid crystal light bulb for the blue color has a structure same as that of the liquid crystal light bulb 31 shown in FIG. 1. The liquid crystal light bulb for the blue color incorporates the optical compensator 85 for improvement of contrast in an inner side portion of the first polarization filter 31b equivalent to the incidence side of the pair of polarization filters 25e. Similarly, the liquid crystal panel 25b for the green light arranged in a second optical path OP2 and the polarization filters 25f, 25f corresponding to the liquid crystal panel 25b constitute a liquid crystal light bulb for the green color. The liquid crystal panel 25c for the red light arranged in a third optical path OP3 and the polarization filters 25g, 25g constitute a liquid crystal light bulb for the red color. These liquid crystal light bulbs for the green color and the red color have structures same as that of the liquid crystal light bulb 31 shown in FIG. 1.

The blue light branched by being transmitted through the first dichroic mirror 23a of the color-separation optical system 23 is made incident on the first liquid crystal panel 25a for the blue light via the field lens 23f. The green light branched by being reflected by the second dichroic mirror 23b of the color-separation optical system 23 is made incident on the second liquid crystal panel 25b for the green light via the field lens 23g. The red light branched by being transmitted through the second dichroic mirror 23b is made incident on the third liquid crystal panel 25c for the red color via the field lens 23h. The respective liquid crystal panels 25a to 25c are light modulators of a non-light emission type that modulate a spatial intensity distribution of illuminating light made incident thereon. The lights of the three colors made incident on the liquid crystal panels 25a to 25c are modulated according to driving signals or image signals inputted to the liquid crystal panels 25a to 25c as electric signals, respectively. In that case, by the polarization filters 25e, 25f, and 25g, polarization directions of the illuminating lights made incident on the respective liquid crystal panels 25a to 25c are adjusted and component lights in predetermined polarization directions are extracted from modulated lights emitted from the respective liquid crystal panels 25a to 25c.

The cross dichroic prism 27 is a light combining member and assumes a substantially square shape in a plan view obtained by bonding four rectangular prisms. A pair of dielectric multilayer films 27a and 27b crossing in an X shape are formed on interfaces where the rectangular prisms are bonded. One first dielectric multilayer film 27a reflects the blue light and the other second dielectric multilayer film 27b reflects the red light. This cross dichroic prism 27 reflects the blue light from the liquid crystal panel 25a on the first dielectric multilayer film 27a and emits the blue light to the right side in a traveling direction thereof. The cross dichroic prism 27 causes the green light from the liquid crystal panel 25b to travel straight and emits the green light via the first and second dielectric multilayer films 27a and 27b. The cross dichroic prism 27 reflects the red light from the liquid crystal panel 25c on the second dielectric multilayer film 27b and emits the red light to the left side in a traveling direction thereof.

The projection lens 29 projects image light of a color obtained by combining the respective color lights with the cross dichroic prism 27 on a screen (not shown) at a desired magnification. In other words, a color moving image or a color still image of the desired magnification corresponding to the driving signals or the image signals inputted to the respective liquid crystal panels 25a to 25c is projected on the screen.

### Fourth Embodiment

A liquid crystal light bulb (a light modulator) as a liquid crystal device according to a fourth embodiment of the invention will be hereinafter explained. The liquid crystal light bulb according to the fourth embodiment is a modification of the liquid crystal light bulb according to the first embodiment. Components of the liquid crystal light bulb not specifically explained are the same as those in the first embodiment.

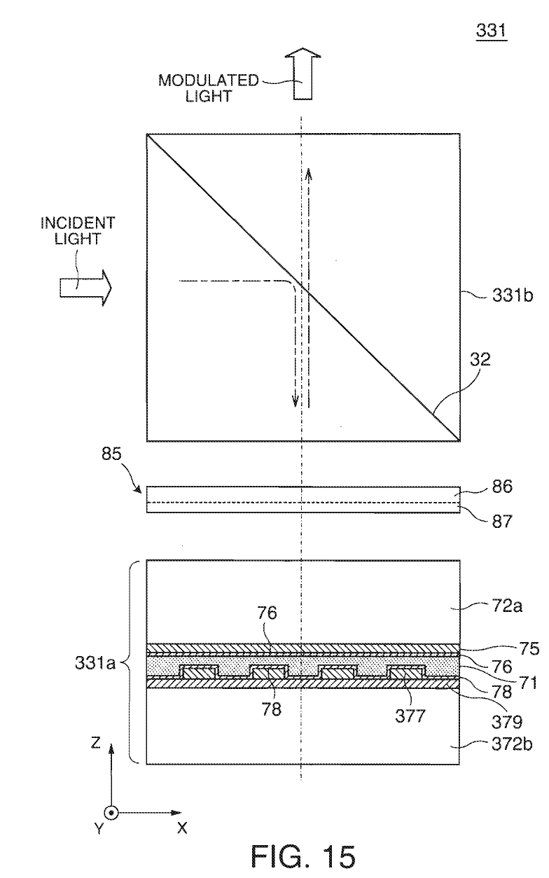

FIG. 15 is an enlarged sectional view for explaining a structure of the liquid crystal light bulb according to the fourth embodiment. A liquid crystal light bulb 331 shown in the figure includes a liquid crystal device 331a, a polarized beam splitter 331b, and the optical compensator 85.

In the liquid crystal light bulb 331, the liquid crystal device 331a is a liquid crystal panel of a reflection type that changes a polarization direction of incident light by a unit of pixel according to an input signal. The liquid crystal device 331a includes a first substrate 72a on a front side and a second substrate 372b on a rear side with the liquid crystal layer 71 formed of, for example, liquid crystal operating in a vertical orientation mode (i.e., liquid crystal of a vertical orientation type) placed between the substrates. The first substrate 72a on the front side, i.e., an incidence and emission side and portions around the first substrate 72a are the same as those in the first embodiment except that a black matrix is not present. On the liquid crystal layer 71 side of the second substrate 372b on the rear side, plural reflection pixel electrodes 377 arranged in a matrix shape are formed via a circuit layer 379. A thin-film transistor (not shown) provided in the circuit layer 379 is electrically connected to the respective reflection pixel electrodes 377. The orientation film 78 is formed on the circuit layer 379 and the reflection pixel electrodes 377. The first and second substrates 72a and 372b, the liquid crystal layer 71 between the first and the second substrates 72a and 372b, and the electrodes 75 and 377 form a liquid crystal cell for changing a polarization state of incident light. Each pixel forming the liquid crystal cell includes one pixel electrode 377, the common electrode 75, and the liquid crystal layer 71 placed between the pixel electrode 377 and the common electrode 75.

In the liquid crystal light bulb 331, the polarized beam splitter 331b is provided instead of the polarization filters 31b and 31c in FIG. 1. The polarized beam splitter 331b performs the adjustment for a polarization direction of light made incident on the liquid crystal device 331a and a polarization direction of light emitted from the liquid crystal device 331a. A polarized-light separating film 32 for separating polarized light is built in this polarized beam splitter 331b as a polarizing member.

This polarized beam splitter 331b reflects S polarized light of the incident light with the polarized-light separating film 32 and makes the S polarized light incident on the liquid crystal device 331a. The polarized beam splitter 331b emits P polarized light transmitted through the polarized-light separating film 32 of modulated light emitted from the liquid crystal device 331a. In other words, in an OFF state in which a voltage is not applied to the liquid crystal layer 71, since the S polarized light is emitted from the liquid crystal device 331a and reflected on the polarized-light separating film 32 of the polarized beam splitter 331b, it is possible to secure a maximum light shielding state (a minimum luminance state) for image light. In an ON state in which a voltage is applied to the liquid crystal layer 71, since the P polarized light is emitted from the liquid crystal device 331a and transmitted through the polarized-light separating film 32 of the polarized beam splitter 331b, it is possible to secure a maximum transmission state (a maximum luminance state). It is possible to replace the polarized beam splitter 331b with other polarizing members of the reflection type such as a wire grid polarizer arranged to be tilted with respect to a system optical axis.

In the liquid crystal light bulb 331, the optical compensator 85 is arranged in a state parallel to the XY plane perpendicular to the Z direction along the optical axis of the incident light. This optical compensator 85 is obtained by removing the polarizing film 81 and the like from the first polarization filter 31b shown in FIG. 1 and has a two layer structure including the first flat plate 86 and the second flat plate 87 formed of birefringent materials of types different from each other. Specifically, for example, the first flat plate 86 has a negative uniaxial refractive index and the second flat plate 87 has a positive uniaxial refractive index. The optical compensator 85 including the first flat plate 86 and the second flat plate 87 functions as a negative uniaxial birefringent material having a small effective thickness. In other words, the optical compensator 85 functions as a phase difference plate with a small correction amount.

The function of the optical compensator 85 is the same as that in the first embodiment except that an incident light beam travels back and forth between the optical compensator 85 and the liquid crystal layer 71. In the liquid crystal device 331a, total retardation with respect to a vertically incident light is twice as large as that in the liquid crystal device 31a shown in FIG. 1. In the OFF state in which a voltage is not applied to the liquid crystal layer 71, according to the adjustment of the thicknesses of the first and second flat plates 86 and 87 forming the optical compensator 85, polarized light reflected by the polarized beam splitter 331b and made incident on the liquid crystal device 331a and polarized light reflected by the liquid crystal device 331a and made incident on the polarized beam splitter 331b are brought into an identical state. Light shielding against the vertically incident light is perfect. Contrast of an image determined by transmission and light shielding by the liquid crystal light bulb 331 is maximized. Similarly, by adjusting the refractive index ellipsoids RIE21 and RIE22 and the thicknesses of the first and second flat plates 86 and 87 forming the optical compensator 85, it is possible to minimize an integrated value of retardation with respect to illuminating devices having various angular distributions and maximize contrast of an image formed by the liquid crystal light bulb 331.

### Fifth Embodiment

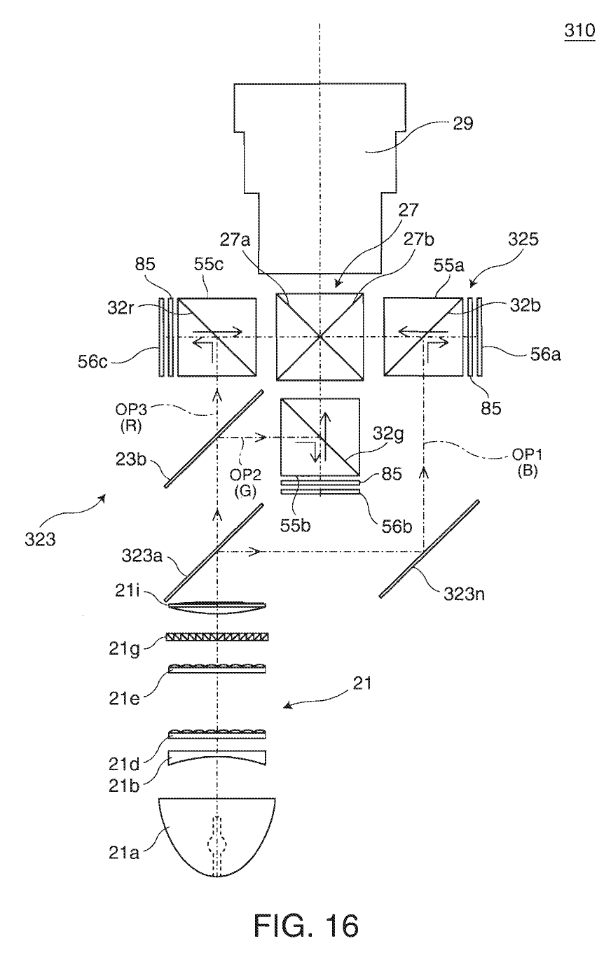

FIG. 16 is a diagram for explaining a structure of an optical system of a projector incorporating the liquid crystal light valve 331 shown in FIG. 15. A projector 310 according to the fifth embodiment is a modification of the projector 10 according to the third embodiment. Components of the liquid crystal light bulb not specifically explained are the same as those in the third embodiment.

This projector 310 includes the light source device 21 that generates light source light, a color-separation optical system 323 that divides the light source light from the light source device 21 into three colors of red, green, and blue, a light modulating unit 325 that is illuminated by illumination lights of the respective colors emitted from the color-separation optical system 323, the cross dichroic prism 27 that combines image lights of the respective colors from the light modulating unit 325, and the projection lens 29 as a projection optical system for projecting light transmitted through the cross dichroic prism 27 on a screen (not shown).

The color-separation optical system 323 includes first and second, dichroic mirrors 323a and 23b and a reflection mirror 323n. In this color-separation optical system 323, the light source light of a substantially white color from the light source device 21 is made incident on the first dichroic mirror 323a. The blue light reflected by the first dichroic mirror 323a is made incident on a polarized beam splitter 55a through the reflection mirror 323n while keeping, for example, the state of the S polarized light. The green light transmitted through the first dichroic mirror 323a and reflected by the second dichroic mirror 23b is made incident on the polarize beam splitter 55b while keeping, for example, the state of the S polarized light. The red light having passed through the second dichroic mirror 23b is made incident on the polarized beam splitter 55c while keeping, for example, the state of the S polarized light.

The light modulating unit 325 includes three polarized beam splitters 55a, 55b, and 55c and three liquid crystal panels 56a, 56b, and 56c. The polarized beam splitter 55a and the liquid crystal panel 56a for blue light constitute a liquid crystal light bulb for the blue color for two-dimensionally subjecting the blue light to luminance modulation on the basis of image information. The liquid crystal light bulb for the blue color has a structure same as that of the liquid crystal light bulb 331 shown in FIG. 15. Similarly, the polarized beam splitter 55b and the liquid crystal panel 56b for the green light constitute a liquid crystal light bulb for the green color. The polarized beam splitter 55c and the liquid crystal panel 56c for the red light constitute a liquid crystal light bulb for the red color. These liquid crystal light bulbs for the green color and the red color have structures same as that of the liquid crystal light bulb 331 shown in FIG. 15. Specifically, the polarized beam splitters 55a, 55b, and 55c correspond to the polarized beam splitter 331b in FIG. 15 and have polarized-light separating films 32b, 32g, and 32r built therein. The optical compensators 85 are arranged between the polarized beam splitters 55a, 55b, and 55c and the liquid crystal panels 56a, 56b, and 56c, respectively, for improvement of contrast.

The invention has been explained according to the embodiments. However, the invention is not limited to the embodiments. It is possible to carry out the invention in various forms without departing from the spirit of the invention. For example, modifications described below are also possible.

In the embodiments, the examples in which sapphire and crystal are used for the optical compensator 85 are explained. However, it is also possible to use negative uniaxial crystals other than sapphire (e.g., calcite, KDP, and ADP) and positive uniaxial crystals (e.g., yttrium, vanadate (YVO4), and magnesium fluoride (MgF₂) ).

In the first embodiment and the like, the optical compensator 85 is arranged on the incidence side of the liquid crystal layer 71. However, it is also possible to arrange the optical compensator 85 on the emission side of the liquid crystal layer 71, i.e., before or behind the emission side cover 74b instead of the synthesized supporting plate 185. When a microlens for condensing is formed on the first substrate 72a or the like, from the viewpoint of not substantially changing an angle of a light beam between the optical compensator 85 and the liquid crystal layer 71, it is desirable to arrange the optical compensator 85 on the emission side on the opposite side of the first substrate 72a.

In the embodiments described above, the optical axes OA21 and OA22 of the pair of flat plates 86 and 87 forming the optical compensator 85 are tilted with respect to the incidence plane 85a and the like. However, it is also possible to set the optical axes OA21 and OA22 vertically to the incidence planes 85a and the like of the flat plates 86 and 87. In this case, the optical compensator 85, i.e., the first polarization filter 31b itself is appropriately tilted with respect to the incident light.

In the optical compensator 85, it is also possible to change the order of the first flat plate 86 and the second flat plate 87. In other words, it is also possible to arrange the first flat plate 86 on the emission side and arrange the second flat plate 87 on the incidence side.

It is not always necessary to bond the first flat plate 86 and the second flat plate 87 forming the optical compensator 85 with the adhesive. It is also possible to arrange the flat plates 86 and 87 to be closely attached to each other or opposed to each other via the air and hold the flat plates 86 and 87 with a holder. It is also possible to interpose an isotropic medium other than the adhesive between the flat plates 86 and 87. In this case, taking into account indexes of refraction of the flat plates 86 and 87, it is also possible to provided a wedge angle between the flat plates 86 and 87 such that tilts of the minor axes of the refractive index ellipsoid RIE21 and the refractive index ellipsoid RIE22 of the flat plates coincide with each other with the optical path VP as a reference.

It is also possible to interpose an anisotropic medium between the flat plates 86 and 87. In this case, an optical axis of the anisotropic medium is arranged to coincide with the optical axes of the flat plates 86 and 87.

In the explanation of the embodiments, the optical compensator 85 is incorporated in the liquid crystal light bulbs 31, 131, and 331 of the vertical orientation type. However, it is also possible to incorporate the same optical compensator 85 in a liquid crystal light bulb of a TN type. Moreover, it is also possible to incorporate, for optical compensation and other purposes, an optical element including the first flat plate 86 and the second flat plate 87 in another place (e.g., in the color-separation optical system 23, the projection lens 29, etc.) of the projector 10.

In the examples explained in the fourth and fifth embodiments, the S polarized light reflected by the polarized-light separating elements of the polarized beam splitters 331b, 55a, 55b, and 55c is made incident on the liquid crystal devices 331a, 56a, 56b, and 56c via the optical compensators 85. The P polarized light from the liquid crystal devices 331a, 56a, 56b, and 56c transmitted through the polarized-light separating elements of the polarized beam splitters 331b, 55a, 55b, and 55c is emitted as image light. However, it is also possible to make the P polarized light transmitted through the polarized-light separating elements of the polarized beam splitters 331b, 55a, 55b, and 55c incident on the liquid crystal devices 331a, 56a, 56b, and 56c via the optical compensator 85 and emit the S polarized light from the liquid crystal device 331a reflected by the polarized-light separating elements of the polarized beam splitters 331b, 55a, 55b, and 55c as image light.

In the projectors 10 and 310 according to the embodiments, the light source device 21 includes the light source lamp 21a, the pair of fly-eye optical systems 21d and 21e, the polarization converting member 21g, and the superimposing lens 21i. However, it is also possible to omit the fly-eye optical systems 21d and 21e, the polarization converting member 21g, and the like and replace the light source lamp 21a with another light source such as an LED.

In the embodiments, color separation of illumination lights is performed using the color-separation optical systems 23 and 323, modulation of the respective colors is performed in the light modulating units 25 and 325, and, then, combination of images of the respective colors is performed in the cross dichroic prism 27. However, it is also possible to form an image with a single liquid crystal panel, i.e., the liquid crystal light bulb 31.

In the embodiments, only the examples of the projectors 10 and 310 in which the three liquid crystal panels 25a to 25c and 56a to 56c are used, respectively, are explained. However, it is also possible to apply the invention to a projector in which two liquid crystal panels are used or a projector in which four or more liquid crystal panels are used.

In the embodiments, only the example of the projector of the front type that projects light from a direction for observing the screen is explained. However, it is also possible to apply the invention to a projector of a rear type that projects light from an opposite side of the direction for observing the screen.

What is claimed is:

1. A projector that includes an optical device, the optical device comprising:
a first flat plate formed of a negative uniaxial refractive material, the first plate having an incidence plane and an emission plane parallel to each other and having an optical axis; and
a second flat plate formed of a positive uniaxial refractive material, the second flat plate having an incidence plane and an emission plane parallel to the incidence plane of the first flat plate, respectively, and having an optical axis substantially parallel to the optical axis of the first flat plate, wherein
a predetermined phase difference is given to light using the first and second flat plates as a pair by adjusting the thickness of the first flat plate and the thickness of the second flat plate.

2. A projector according to claim 1, wherein the optical axis of the first flat plate and the optical axis of the second flat plate are arranged such that a ray that is parallel to the optical axis of the first flat plate when the ray is transmitted through the first flat plate changes to a ray that is parallel to the optical axis of the second flat plate when the ray is transmitted through the second flat plate.

3. A projector according to claim wherein at least one of the first and second flat plate is arranged in contact with an optical element to be heated.

4. A projector according to claim 3, wherein the optical element to be heated includes a polarizing film that transmits linear polarized light in a predetermined direction.

5. A projector according to claim 1, wherein the first and second flat plates are formed of inorganic materials, respectively.

6. A projector according to claim 5, wherein the first flat plate is formed of sapphire and the second flat plate is formed of crystal.

7. A projector according to claim 1, wherein, as a positional relation between the first and second flat plates, the first and second flat plates are in direct contact with each other, an isotropic medium is interposed between the first and second flat plates, or an anisotropic medium having an optical axis coinciding with the optical axes of the first and second flat plates are interposed between the flat plates.

8. A projector according to claim 7, wherein the first and second flat plates are bonded via an adhesive.

9. A projector according to claim 1, wherein
the optical device is a light modulator including a liquid crystal cell that holds liquid crystal, and at least one polarizing member arranged in association with the liquid crystal cell, and
the first and second flat panels are arranged between the liquid crystal cell and the at least one polarizing member.

10. A projector according to claim 9, wherein
the liquid crystal panel is arranged between the first flat plate and the second flat plate, and
an influence of birefringence of the liquid crystal panel is compensated for by the first and second flat plate.

11. A projector according to claim 9, wherein the optical device further comprises:
an illuminating device that illuminates the light modulator; and
a projection lens that projects an image formed by the light modulator.
